(19) United States
(12) Patent Application Publication
(10) Pub. No.: US 2007/0068054 A1
(43) Pub. Date: Mar. 29, 2007

(54) Picture holder

(76) Inventor: Hen-An Chou, Taipei Hsien (TW)

Correspondence Address: Hen-An Chou, 235 Chung - Ho, Box 8-24, Taipei, TW

(21) Appl. No.: 11/604,145

(22) Filed: Nov. 27, 2006

Related U.S. Application Data
(63) Continuation-in-part of application No. 10/821,598, filed on Apr. 8, 2004, now abandoned.

(51) Int. Cl. G09F 7/00

(52) U.S. Cl. 40/492

(57) ABSTRACT

A picture holder comprises a clamping unit installed with two elastic rings; the elastic rings passing through holes of the clamping unit; each ring is a C ring, that is, an opening is formed in the ring; the two elastic rings can be opened for locating a photograph so as to fix the photograph; and a supporting portion fixed to the clamping unit; the supporting portion including two sheets; the two sheets of the supporting portion can be expanded so that the supporting portion stands upon a plane. One sheet of the supporting portion is installed with a slide portion; the slide portion having at least one small hole. The supporting portion has at least one protrusion. By aligning the protrusion of the slide portion to the small hole of the supporting portion, the slide portion is fixed to the supporting portion at a selected position.

The present invention is a continuation in part (CIP) of U.S. Patent application with Ser. No. 10/821,598 which is assigned to and invented by the inventor of the present invention, and thus the contents of the invention are incorporated into the present invention as a part of the present invention.

### FIELD OF THE INVENTION

The present, invention relates to picture holders, and particularly to a picture holder having a supporting portion which can be expanded and stands upon a plane. The photographs can be installed at two sides of the supporting portion so that users can view of the photographs from two sides of the picture holder.

### BACKGROUND OF THE INVENTION

Referring to FIGS. 1(a) and 1(b), a prior art picture holder is illustrated. The prior art picture holder 1 includes an upper frame 1, a lower frame 12 and a post 13. Photographs are placed between the upper frame 11 and lower frame 12. The post 13 serves to make the picture holder 1 stand on a plane. This prior art arrangement will cause the picture holder to vibrate easily and thus the picture holder 1 is easy to fall down.

However, the above-mentioned prior art arrangement has some defects, such as the picture holder is easy to fall down. It is difficult to install or update the photographs. Furthermore only one photograph can be displayed at one time.

### SUMMARY OF THE INVENTION

Accordingly, the primary object of the present invention is to provide a picture holder. The supporting portion can be expanded and stands upon a plane. Thus it is difficult to fall down.

Another object of the present invention is to provide a picture holder, wherein in updating the photographs, it only needs to open two elastic rings for locating photographs and then the elastic rings are closed. The operation is easy.

A further object of the present invention is that a plurality of photographs can be installed to the picture holder at the same time and two sides of the picture holder can display photographs. The user can lift one photograph for viewing another one.

To achieve above objects, the present invention provides a picture holder which comprises a clamping unit installed with two elastic rings; the elastic rings passing through holes of the clamping unit; each ring is a C ring, that is, an opening is formed in the ring; the two elastic rings can be opened for passing through a photograph so as to fix the photograph; and a supporting portion fixed to the clamping unit; the supporting portion including two sheets; the two sheets of the supporting portion can be expanded so that the supporting portion stands upon a plane. The photograph is a single face photograph or a double face photograph. The supporting portion is fixed to the clamping unit by using screws. One sheet of the supporting portion is installed with a slide portion; the slide portion has at least one small hole; the supporting portion locating the slide portion has at least one protrusion; wherein by aligning the protrusion of the slide portion to the small hole of the supporting portion, the slide portion can be fixed to the supporting portion at a selected position.

The various objects and advantages of the present invention will be more readily understood from the following detailed description when read in conjunction with the appended drawing.

### BRIEF DESCRIPTION OF THE DRAWINGS

FIG. 1a is a schematic perspective view of a prior art picture holder.

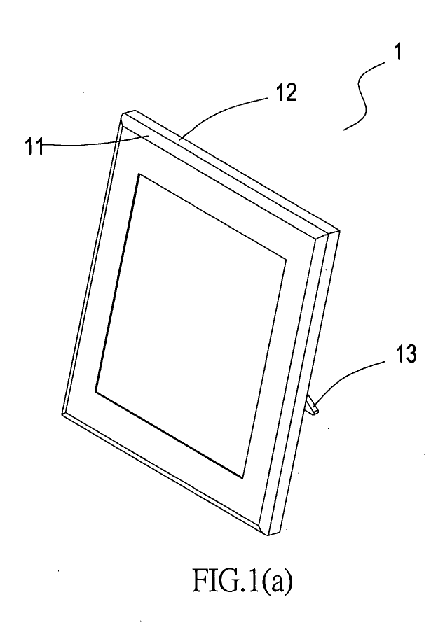

FIG. 1b is a schematic view showing the use of the prior art picture holder.

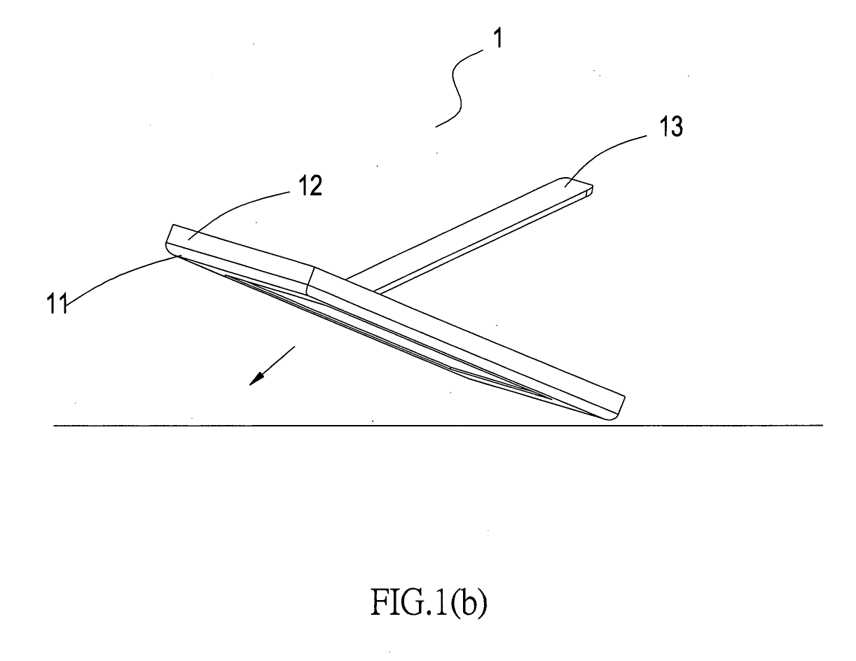

FIG. 2 is an exploded perspective view of the picture holder of the present invention.

FIG. 3 is a schematic view about the air inflation cushion with cells having helical edges of the present invention.

FIG. 4 is a schematic view showing the application of the present invention.

FIG. 5 is a schematic view showing another application of the present invention.

FIG. 6 is an exploded view showing the slide portion and picture holder of the present invention.

FIG. 7 is a schematic view showing the engagement of the slide portion according to the present invention.

FIG. 8 is a schematic view showing the adjustment of the supporting portion according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

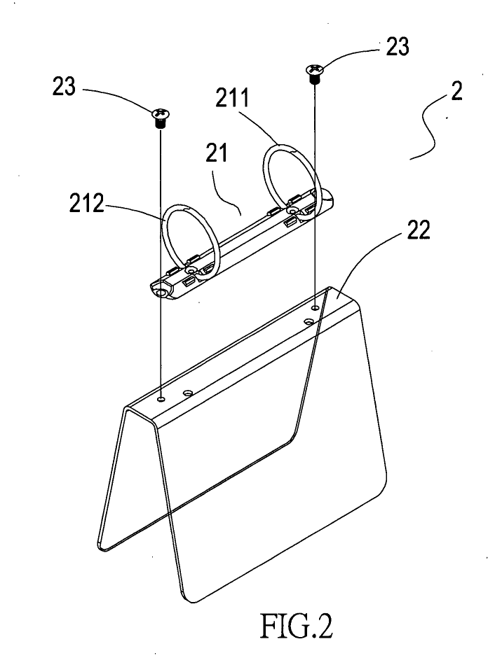

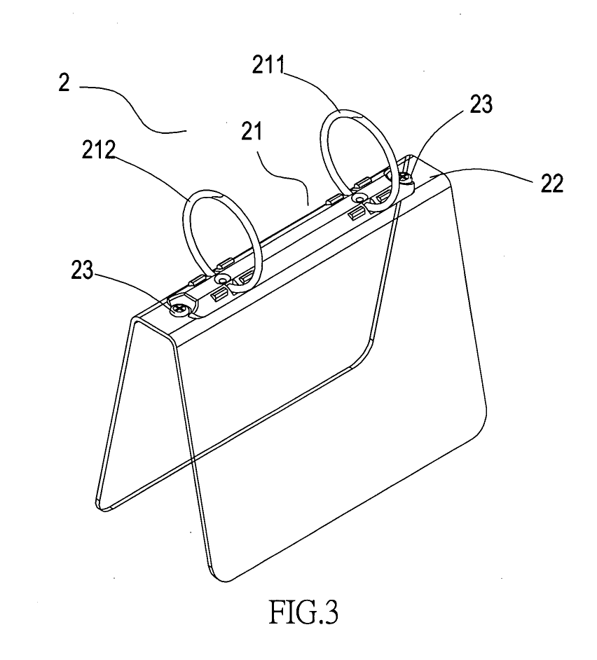

Referring to FIGS. 2 and 3, the structure of the present invention is illustrated. The picture holder 2 has the following elements.

A clamping unit 21 is installed with two elastic rings 211, 212. The elastic rings 211, 212 pass through the holes of the clamping unit 21. Each ring is a C ring, that is, an opening is formed in the ring. The two elastic rings 211, 212 can be opened for engaging with a photograph so as to fix the photograph.

A supporting portion 22 is screwed to the clamping unit 21 by using screws 23. The supporting portion 22 includes two sheets. The two sheets of the supporting portion 22 can be expanded so that the supporting portion 22 stands upon a plane and thus a picture holder 2 is formed.

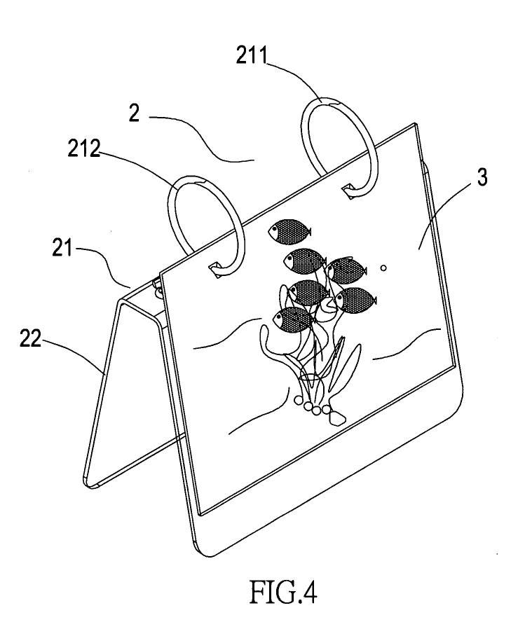

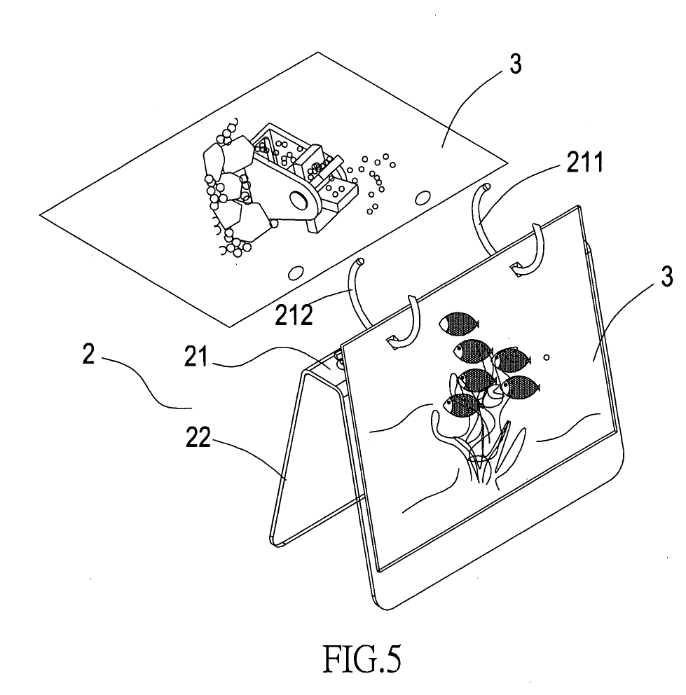

With reference to FIGS. 4 and 5, it is illustrated that when the two elastic rings 211, 212 are opening, a plurality of photographs 3 are located on the elastic rings 211, 212 and then the two elastic rings 211, 212 are closed so that the photographs 3 can be lifted upwards and then are driven to another side of the supporting portion 22. Thus the two sides of the supporting portion 22 can be used to display the photographs 3.

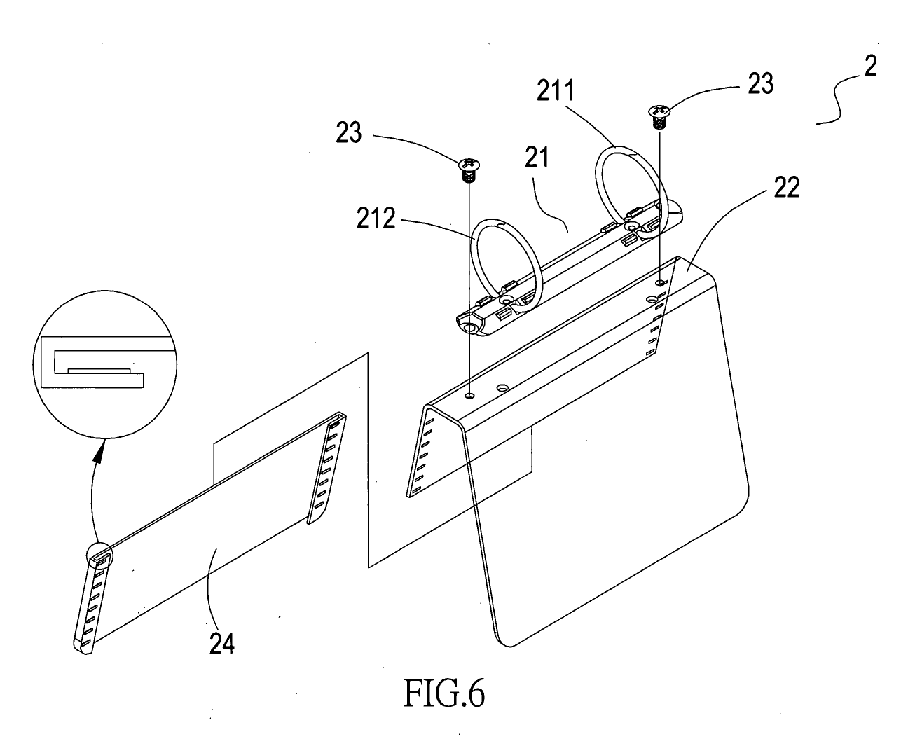

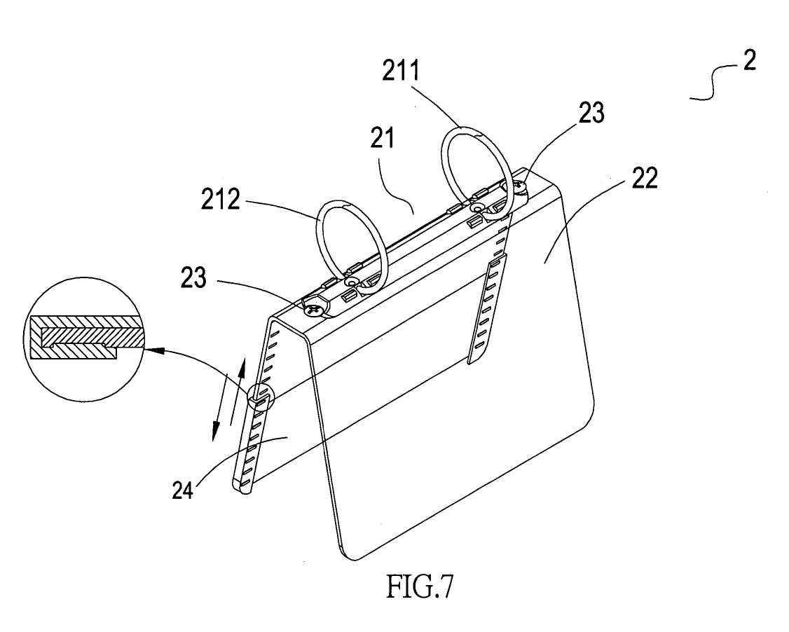

Referring to FIGS. 6 and 7, it is illustrated that one sheet of the supporting portion 22 is installed with a slide portion 24. The slide portion 24 has at least one small hole. The supporting portion 22 locating the slide portion 24 has at least one protrusion. By aligning the protrusion of the slide portion 24 to the small hole of the supporting portion 22, the slide portion 24 is fixed to the supporting portion 22. Thus the slide portion 24 is adjusted so that the length of the supporting portion 22 at the side is adjusted to a desired one.

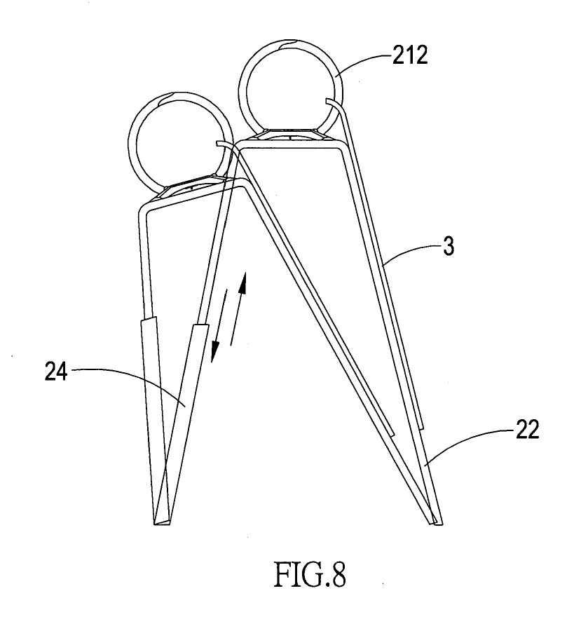

The adjustment of the supporting portion 22 is illustrated in FIG. 8 so that the supporting portion 22 is adjusted to a desired orientation.

Advantages of the present invention will be described herein. In the present invention, the two sheets of the supporting portion 22 can make the picture holder 2 stand upon a plane steadily not to fall down. The update of new photograph is performed easily by only expanding the rings. A plurality of photographs are clamped by the elastic rings and the photographs are arranged at two side of the supporting portion of the picture holder, users can view the photographs at any sides.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A picture holder comprising:
a clamping unit installed with two elastic rings; the elastic rings passing through holes of the clamping unit; each ring being a C ring, that is, an opening is formed in the ring; the two elastic rings can be opened for locating a photograph so as to fix the photograph; and
a supporting portion fixed to the clamping unit; the supporting portion including two sheets; the two sheets of the supporting portion being expandable so that the supporting portion stands upon a plane.

2. The picture holder as claimed in claim 1, wherein the photograph is a single face photograph or a double face photograph.

3. The picture holder as claimed in claim 1, wherein the supporting portion is fixed to the clamping unit by using screws.

4. The picture holder as claimed in claim 1, wherein one sheet of the supporting portion is installed with a slide portion; the slide portion has at least one small hole; the supporting portion locating the slide portion has at least one protrusion; wherein by aligning the protrusion of the slide portion to the small hole of the supporting portion, the slide portion being fixed to the supporting portion at a selected position.
